(19) United States
(12) Patent Application Publication
(10) Pub. No.: US 2023/0260377 A1
(43) Pub. Date: Aug. 17, 2023

(54) SENSORY SYSTEM

(71) Applicant: Lester Walter Lino Ramos, Beaverton, OR (US)

(72) Inventors: Lester Walter Lino Ramos, Beaverton, OR (US); Rodolfo Orlando Lino Ramos, Beaverton, OR (US)

(21) Appl. No.: 17/672,494

(22) Filed: Feb. 15, 2022

(51) Int. Cl. G08B 6/00; G08B 21/02

(52) U.S. Cl. CPC G08B 6/00; G08B 21/0266

(57) ABSTRACT

A sensory system includes a first band adapted to be worn by a first user, and a second band adapted to communicate with the first band and worn by a second user. Further, each of the first band and the second band is associated with a category. The second band includes a transceiver to facilitate a communication of the second band with the first band, a sensor to determine a distance between the first band and the second band, at least one vibrator to facilitate the vibration of the second band, and a controller arranged in communication with the transceiver, the at least one vibrator, and the sensor. The controller is configured to actuate the vibrator in response to the category of the first band and the category of the second band, and the determined distance of the second band from the first band. Furthermore, it describes a method for detecting the present of machinery, or people who wears a band, in a determined zone.

### TECHNICAL FIELD

The present disclosure relates, generally, to a sensory system having wearable bands. More particularly, the present disclosure pertains to a sensory system having a plurality of bands worn by a plurality of users to trigger alerts to the wearer of the bands.

### BACKGROUND

Typically, in workplaces warnings signs/signals and tools developed to create a safer environment uses visual and sound stimulus. However, workplaces, especially warehouses, industries, and other workplaces that are more prone to noise, the sound stimulus for alarming the users/operators almost becomes irrelevant. In addition, using visual stimuli, such as flashing lights, mirrors, yellow vests, glow paint, signals, security barriers and other visual elements overwhelm the visual perception of the users/operators working on the site. Further, the brain processes the visual inputs of attention only for that movement and it gets difficult to evaluate an emergency situation, which is undesirable.

### SUMMARY

According to an aspect of the disclosure a sensory system is disclosed. The sensory system includes a first band adapted to be worn by a first user, and a second band adapted to communicate with the first band and worn by a second user. Further, each of the first band and the second band is associated with a category. The second band includes a transceiver to facilitate a communication of the second band with the first band, a sensor to determine a distance between the first band and the second band, at least one vibrator to facilitate the vibration of the second band, and a controller arranged in communication with the transceiver, the at least one vibrator, and the sensor. The controller is configured to actuate the vibrator in response to the category of the first band and the category of the second band, and the determined distance of the second band from the first band. Furthermore, it describes a method for detecting the present of machinery, or people who wears a band, in a determined zone.

In an embodiment, the category includes a first category and a second category. Each of the first band and the second band is associated with one of the first category or the second category.

In an embodiment, the first category indicates a first user category and the second category indicates a second user category.

In an embodiment, the controller actuates the vibrator when at least one of the first band or the second band is associated with the first category.

In an embodiment, the controller actuates the vibrator at a first tacton when one of the first band and the second band is associated with the first category and other of the first band and the second band is associated with the second category and the determined distance is less than a first predefined distance.

In an embodiment, the controller actuates the vibrator at a third tacton if the first band and the second band are present within the first predefined distance after an elapse of a predetermined time from an actuation of the vibrator at the first tacton.

In an embodiment, the controller actuates the vibrator at a second tacton when each of the first band and the second band is associated with the first category and the determined distance is less than a second predefined distance.

In an embodiment, the controller actuates the vibrator at a third tacton if the first band and the second band are present within the second predefined distance after an elapse of a predetermined time from an actuation of the vibrator at the second tacton.

According to an aspect of the disclosure, a band adapted to be worn by a user is disclosed. The band includes a transceiver to facilitate a communication of the band with another band, a sensor to determine a distance of the band from the another band, at least one vibrator adapted to vibrate, and a controller arranged in communication with the transceiver, the vibrator, and the sensor. The controller is configured to actuate the vibrator in response to a category of the band and a category of the another band, and the determined distance of the band from the another band.

In an embodiment, the category includes a first category and a second category, and the band is associated with one of the first category or the second category.

In an embodiment, the controller is adapted to actuate the vibrator at a first tacton when the category of the band is different from the category of the another band and the determined distance is less than a first predefined distance.

In an embodiment, the controller is adapted to actuate the vibrator at a third tacton when the band is present within the first predefined distance of the another band after an elapse of a predetermined time from an actuation of the vibrator at the first tacton.

In an embodiment, the controller is adapted to actuate the vibrator at a second tacton in response to the determined distance being less than a second predefined distance, and the category of the band being identical to the category of the another band and the category of the first band being the first category.

In an embodiment, the controller is adapted to actuate the vibrator at a third tacton when the band is present within the second predefined distance of the another band after an elapse of a predetermined time from an actuation of the vibrator at the second tacton.

According to an aspect of the disclosure a method for detecting a presence of users in a zone is disclosed. The method includes providing a first band worn by a first user and a second band worn by a second user. Each of the first band and the second band is associated with a category. The method includes determining a distance between the first band and the second band. Further the method includes vibrating at least one of the first band or the second band in response to the categories of both the first band and the second band, and the determined distance between the first band and the second band.

In an embodiment, the category includes a first category and a second category, and each of the first band and the second band is associated with one of the first category or the second category. The first category indicates a first user category and the second category indicates a second user category.

In an embodiment, at least one of the first band or the second band vibrates at a first tacton when one of the first band and the second band is associated with the first category and other of the first band and the second band is associated with the second category and the determined distance is less than a first predefined distance.

In an embodiment, at least one of first band or the second band vibrates at the third tacton when the first band and the second band are within the first predefined distance after an elapse of a predetermined time from an actuation of at least one of first band or the second band at the first tacton.

In an embodiment, at least one of the first band or the second band vibrates at a second tacton when each of the first band and the second band is associated with the first category and the determined distance is less than a second predefined distance.

In an embodiment, at least one of first band or the second band vibrates at the third tacton when the first band and the second band are within the second predefined distance after an elapse of a predetermined time from an actuation of at least one of first band or the second band at the second tacton.

### BRIEF DESCRIPTION OF THE DRAWINGS

FIG. 1 illustrates a schematic view of a sensory system having a plurality of bands adapted to be worn by a plurality of users, in accordance with an embodiment of the disclosure;

FIG. 2 illustrates a schematic view of the band of the sensory system of the FIG. 1 depicting various components of the band, in accordance with an embodiment of the disclosure;

FIG. 3 illustrates a method of operation of the sensory system of the FIG. 1, in accordance with an embodiment of the disclosure;

FIG. 4 illustrates a method for configuring one or more parameters of the band, in accordance with an embodiment of the disclosure; and

FIG. 5 illustrates a method for transferring data from the band to a central station, in accordance with an embodiment of the disclosure.

### DETAILED DESCRIPTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element’s or feature’s relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

For the purposes of the present disclosure, at least one of A, B, or C includes, for example, A only, B only, or C only, as well as A and B, A and C, B and C; or A, B, and C, or any other all combinations of A, B, and C.

For the purposes of the present disclosure, one of A or B includes, for example, A only, B only.

For the purposes of the present disclosure, one of A and B includes, for example, A only, B only.

As used herein, the term “controller” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

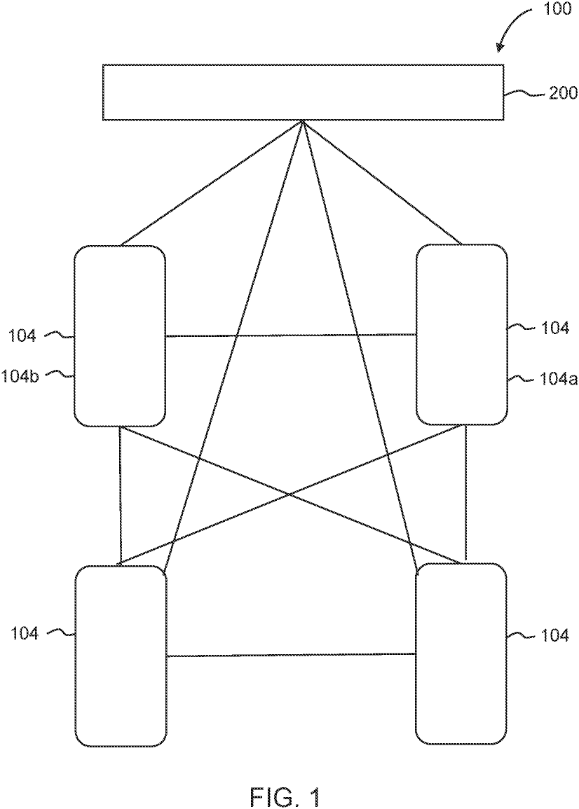

Referring to FIG. 1, a sensory system 100 including a plurality of bands 104 worn by a plurality of users is shown. The sensory system 100 facilitates in tracking the locations of one or more users within a vicinity of a user and generates vibro-tactile messages for the users. The bands 104 are configured to communicate with each other present in an area, for example, a factory, and are adapted generate a vibrotactile message based on user categories associated with bands 104 and a distance of the band 104 from one or more of other bands 104. The interaction of bands 104 with each other is described later in the description. Further, the one or more of the plurality of bands 104 may be configured as a first category and one or more of the plurality of bands 104 may be configured as a second category. As an example, the bands 104 having the first category is to be worn by the users operating the machinery, vehicles, cranes or other heavy or moveable equipment’s and the bands 104 having the second category is to be worn by the workers that are walking, constructing or employed in other things on the ground. Although two categories of the bands 104 are contemplated, it may be envisioned that the bands 104 may be associated with more than two categories. Further, the sensory system 100 includes a central station 200, that can be or not mobile, in communication with the plurality of bands 104 and facilitates the storage and transmission of the data from the plurality of bands 104 of the sensory system 100.

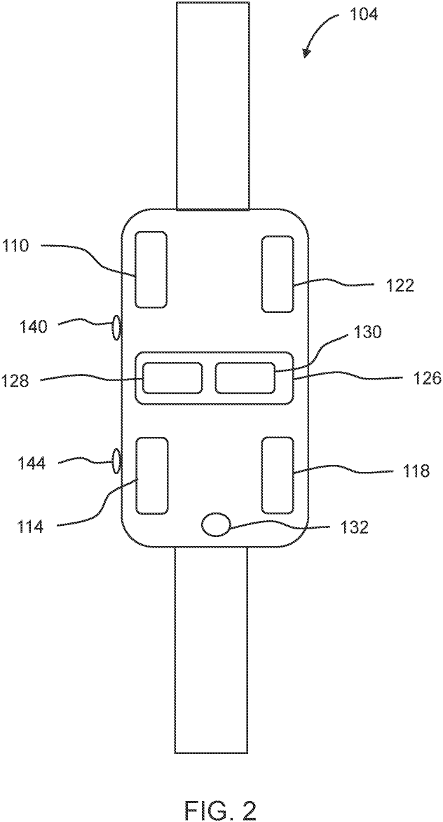

Referring to FIG. 2, a schematic of a band 104, according to an embodiment, is shown. In an embodiment, the band 104 is a wristband adapted to be worn on a wrist of a user and includes a transceiver 110, a sensor 114, a battery 118, a vibrator 122, and a controller 126. The transceiver 110 is adapted to facilitate a communication of the band 104 with other bands 104 present in the vicinity of the band 104 and a central station 200, and facilitates an exchange of data between the band 104 and other bands 104 and/or the central station 200. In an embodiment, the signals transmitted and received by the transceiver 110 may be a plurality of analog signals or a plurality of digital signals for facilitating the wireless communication of the band 104 with the other bands 104. The transceiver 110 continuously broadcasts the wireless signals in all direction of a particular frequency. In an embodiment, the transceiver 110 may broadcasts the wireless signals after each frequency of time as an example, the frequency of the signal transmitted is one-tenth of a second. Additionally, the transceiver 110 facilitates the receiving of one or more signals being broadcasted from the other bands 104.

Further, the sensor 114 is a distance sensor and is adapted to determine a distance of the band 104 from the other bands 104. In an embodiment, the sensor 114 may be a time-of-flight sensor that sends a signal by the speed of the light and receives the signal reflected by the other band 104 present in the vicinity of the band 104. The sensor 114 calculates distance of the band 104 from the other band 104 by multiplying the round-trip time of the signal by the speed of light, and then dividing by 2. In an embodiment, the sensor 114 uses TWR technology (Two Way Ranging) and RTLS (Real Time Location System) to identify the location and the distance of the other bands 104 from the band 104. Although the sensor 114 is contemplated as the time-of-flight sensor, it may be appreciated that the other types of sensors suitable to determine the distance between the bands may also be utilized.

The vibrator 122 is adapted to vibrate based on the distance of the band 104 from the other bands 104 and is adapted to generate a plurality of vibro-tactile messages. For example, the vibrator 122 is adapted to generate a first vibro-tactile message (i.e., first tacton), a second vibro-tactile message (i.e., a second tacton), a third vibro-tactile message (i.e., third tacton) depending on the distance of the band 104 from other bands 104 and the categories of the band 104 and other bands 104, or a fourth vibro-tactile message (i.e., fourth tacton) to signal low level of battery. It may be appreciated each of the tactons generated by the vibrator varies in one or more of the frequencies of vibration, the amplitude of vibration, the waveform of vibration, the pauses between two vibration pulses or the rhythms. In an embodiment, the vibrator 122 may include a LRA (Linear Resonant Actuator) or a linear vibration motor acting to generate various tactons. As an example, the vibrator 122 may be adapted to vibrate at a frequency between 70 Hz to 8 GHz. Further, in an embodiment, the duration between the vibration pulses is more than the 50 milliseconds, and shorter than 200 milliseconds to avoid any overwhelming of the user perception. In an embodiment, the frequency, the amplitude, the time intervals or the pauses between the two vibration pulses may be configured by a technician.

In some embodiments, the band 104 may include a lightening device 132, for example, a light emitting diode (LED) adapted to generate/display light of various colors. In an embodiment, the lightening device 132 may generate a green light when the band 104 is active or switched ON, while the lightening device 132 may be off when the band 104 is inactive. Also, the lightening device 132 is adapted to generate a red light when a charge of the battery 118 is below a threshold value.

The battery 118 may be a rechargeable battery and may be a lithium-ion battery to facilitate a supply of electrical power to the band 104. To charge the battery 118, the band 104 may include a port (not shown) that facilitates a connection of the band 104 (i.e., the battery) with a power source (not shown) via a suitable cable, for example, a USB cable. In embodiments, the battery 118 may be wirelessly charged. For so doing, the band 104 may include suitable hardware to enable the wireless charging of the battery 118.

Additionally, or optionally, the band 104 may include a mute button 140 to mute the band 104 and avoid all vibrations. The lapse of mute can be pre-configured.

Additionally, the band can be made of a stretchable material such as medical grade silicone, other similar or a combination of materials, and fitted around a user’s wrist, or adhere to a machinery, by a strap or a similar system.

The controller 126 is configured to control various components of the band 104 and is in communication with the sensor 114, the transceiver 110, the vibrator 122, the battery 118, the lightning device 132, and the central station 200. The controller 126 is configured to receive and transmit data from the sensor 114, the transceiver 110, the central station 200, processes the data received from the transceiver 110, the central station 200, the sensor 114, and is adapted to control/actuate the vibrator 122 at various tactons depending on the data received from the sensor 114, the transceiver 110, and the central station 200.

The controller 126 may include a processor 128 for executing specified instructions, which controls and monitors various functions associated with the band 104. The processor 128 may be operatively connected to a memory 130 for storing instructions related to the control of the band 104 and components of the band 104. In an embodiment, the memory 130 may also store various events performed during the operations of the band 104. The processor 128 is adapted to determine the tacton to be delivered by the vibrator 122 based on the user category of the band 104 and one or more of other bands 104 that is present within at least one predefined distance from the band 104. In an embodiment, the memory 130 also stores a user category associated with the band 104, the value of the predefined distances, the lapse of the mute, an identification code of the band 104 and the date and time of interaction with other bands 104. Also, the memory 130 may store an alias or name associated with a wearer of the band 104. It may be appreciated that the user category, the at least one predefined distance, the identification code, and the name or the alias can be changed/updated for the band 104.

The memory 130 as illustrated is integrated into the controller 126, but those skilled in the art will understand that the memory 130 may be separate from the controller 126 but onboard the band 104, and/or remote from the controller 126 and the band 104, while still being associated with and accessible by the controller 126 to store information in and retrieve information from the memory 130 as necessary during the operation of the band 104. Although the processor 128 is defined, it is also possible and contemplated to use other electronic components such as a microcontroller, an application specific integrated circuit (ASIC) chip, or any other integrated circuit device may be used for preforming the similar function. Moreover, the controller 126 may refer collectively to multiple control and processing devices across which the functionality of the band 104 may be distributed. For example, the sensor 114, the transceiver 110, and the vibrator 122, may each have one or more controllers that communicate with the controller 126.

The controller 126 (i.e., the processor 128) is adapted to determine the distances of other bands 104 from the data received by the sensor 114 and is configured to compare the distances with at least one predefined distance stored in the memory 130. Also, the controller 126 is adapted to determine categories of the one or other bands 104 based on the data from the transceiver 110. In an embodiment, the controller 126 is adapted to fetch/receive an identification code of the one or more of other bands 104. In some embodiments, the transceiver 110 fetch/receive the identification codes of all the bands 104 that are able to communicate with the band 104. Based on the category of the other bands 104 and the category of one or other band 104 and distance between the band 104 and other bands 104, the controller 126 is configured to actuate the vibrator 122.

In an embodiment, the controller 126 is configured to actuate the vibrator 122 at the second tacton when the band 104 and other detected band 104 are associated with the first category and the distance between them is less than a second predefined value. In an embodiment, the controller 126 is configured to actuate the vibrator 122 at the first tacton when the band 104 is of the first category and the other detected band is of the second category and the distance between the two bands 104 is less than a first predefined value. Also, the controller 126 is configured to actuate the vibrator 122 at the first tacton when the band 104 is of the second category and the other detected band 104 is of the first category and the distance between the two bands 104 is less than a first predefined value.

Additionally, or optionally, the controller 126 is configured to actuate the vibrator 122 at the third tacton if the other detected band 104 is within associated predefined distance (i.e., the first predefined distance if both bands 104 are of first category and the second predefined distance if one of the bands is of the first category and other of the bands 104 is of the second category) even after an elapse of a predetermined time duration since the first actuation of the vibrator 122. In an embodiment, the controller 126 is configured to actuate the lightning device 132 to generate red light when a level of charge of the battery 118 drops below a threshold value. Also, the controller 126 controls the lightening device 132 to generate green light if the charge of the battery 118 is above the threshold value. In an embodiment, the controller 126 is in communication with the mute button 140 and controls the vibration of the vibrator 122 based on a position/actuation of the mute button 140. In an embodiment, the controller 126 deactivates the vibrator 122 for a predetermine lapse when the mute button 140 is moved to a first position or depressed by the user.

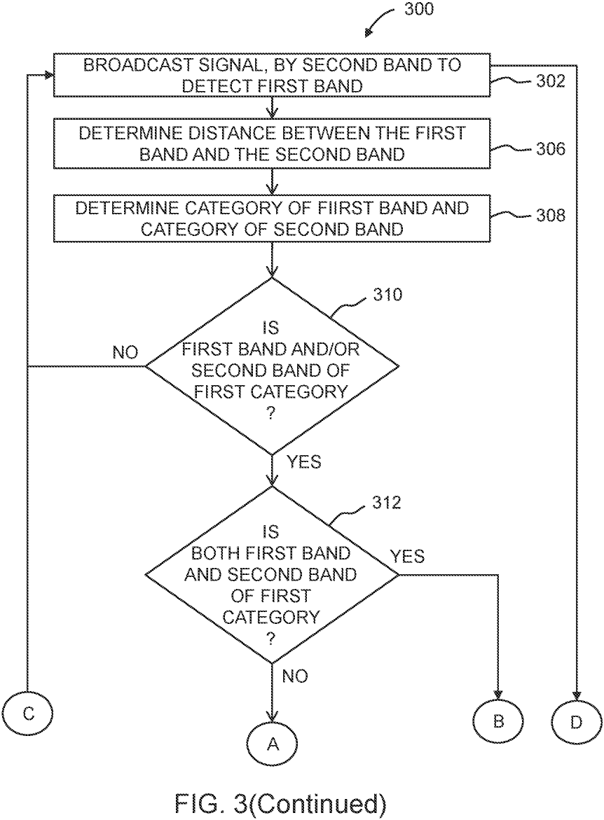

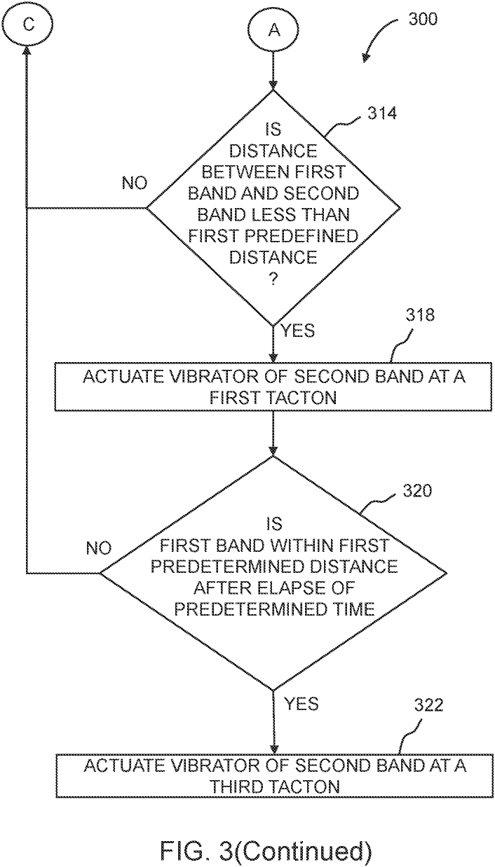

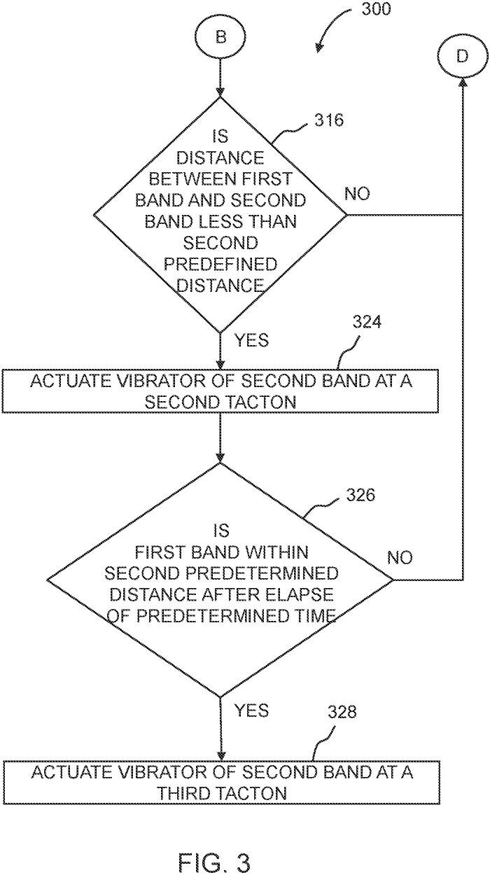

Referring to FIG. 3, a method 300 for operation of the sensory system 100 is explained. The method 300 is described with reference to a method of interaction of a second band 104b with a first band 104a of the sensory system 100, and it may be appreciated that all the bands 104 of the sensory system 100 interacts and function in a similar manner. Also, it may be appreciated that all the bands 104 shown in FIG. 1 are associated with various users/workers working at a worksite. The worksite may be a factory floor, or a warehouse, or a construction site. Accordingly, each of the bands 104 is provided with a unique identification code and is associated with a category that corresponds to a user category of the wearer. For example, a band 104 that is to be worn by a driver or an operator of a machine/vehicle is assigned the first category, while a band 104 that is to be worn by a pedestrian is assigned/associated with the second category. It may be appreciated that the category may be assigned to each of the bands 104 at the worksite by a supervisor/operator. Similarly, the predefined distance, i.e., the first predefined distance and the second predefined distance, may be configured for each band 104 separately and may be changed/configured by the supervisor. Similarly, the supervisor may provide identification code of his/her choice to each band 104. Also, the supervisor may establish the lapse for the mute, which by default is zero in all the band 104. A method of configuration of the band 104 is described later.

Referring to FIG. 3, at a step 302 of the method 300, the transceiver 110 of the second band 104b transmits/broadcasts signal to communicate with one or more of other bands 104, for example, the first band 104a, present at the worksite. The method 300 moves to a step 306 if one or more bands 104, for example, the first band 104a, is detected in a vicinity of the second band 104b. Upon detection of the first band 104a at the work site, or otherwise, the controller 126 (i.e., processor 128) of the second band 104b, at the step 306 of the method 300, determines a distance of the second band 104b from the first band 104a. At a step 308 of the method 300, the controller 126 of the second band 104b (i.e., the processor 128) determines a category of the first band 104a and a category of the second band 104b. The controller 126 (i.e., the processor 128) may identify the category of the first band 104a based on the identification code received from the first band 104a. In an embodiment, the controller 126 (i.e., the processor 128) identify the category of the first band 104a. For so doing, the controller 126 (i.e., the processor 128) shares the identification code with the band in its vicinity, and receives the category associated with identification code from the second band. In an embodiment, the category associated with each of the bands 104 present at the worksite are stored in the memory 130 of each of the bands 104. In such a case, the controller 126 (i.e., the processor 128) may retrieve the category associated with the first band 104a from the memory 130 by comparing the identification code of the first band 104a with the identification codes stored inside the memory 130. Further, the controller 126 (i.e., the processor 128) determines the category of the second band 104b.

Subsequently, the method 300 moves to a step 310. At the step 310, the processor 128 checks if the first band 104 and/or the second band 104b is associated with the first category. The method 300 moves to a step 312 if the processor 128 determines that at least one of the first band 104a or the second band 104b is of the first category, else the method 300 moves to the step 302. At the step 312, the processor 128 determines if both the first band 104a and the second band 104b are of the first category. the method 300 moves to a step 314 if one of the first band 104a and the second band 104b is of the first category and other of the first band 104a and the second band 104b are of the second category, while the method 300 moves to a step 316 if the processor 128 determines that both the first band 104a and the second band 104b are associated with the first category.

At the step 314, the processor 128 checks if the determined distance between the first band 104a and the second band 104b is less than a first predefined distance. The method 300 moves to a step 318 if the determined distance is less than the first predefined distance, else method 300 moves to the step 302. At the step 318, the processor 128 actuates the vibrator 122 of the second band 104b at the first tacton to indicate the wearer of the second band 104b about the presence of a person associated with a different category in the vicinity. For example, the processor 128, by the vibrating the vibrator 122 of the second band 104b, indicates a presence of a pedestrian in the vicinity if the second band 104b is associated with the first category and therefore is worn by an operator of a machine or vehicle. Similarly, the processor 128, by the vibrating the vibrator 122 of the second band 104b, indicates a presence of a driver or an operator of a machine in the vicinity if the second band 104b is associated with the second category and therefore is worn by a pedestrian. Thereafter the method 300 moves to a step 320.

At the step 320, the processor 128 check if the first band 104a is still within the first predefined distance of the second band 104b after elapse of the predetermined duration from the actuation of the second band 104b at the first tacton. The processor 128, at a step 322, actuates the vibrator 122 at a third tacton if the processor 128 detects the presence of the first band 104a within the first predefined distance of the second band 104b after elapse of the predetermined duration from the actuation of the second band 104b at the first tacton. Otherwise, the method 200 moves to the step 302. In this manner, the sensory system facilitates detection of various types of users in the vicinity of a user at a worksite.

At the step 316, the processor 128 checks if the determined distance is less than a second predefined distance. The method 300 moves to a step 324 if the determined distance is less than the second predefined distance, else method 300 moves to the step 302. At the step 324, the processor 128 actuates the vibrator 122 at the second tacton to indicate the wearer of the second band 104b that a wearer of the first category is present in the vicinity of the second band 104b. Thereafter the method 300 moves to a step 326. At the step 326, the processor 128 checks if the first band 104a is still within the second predefined distance of the second band 104b after elapse of a predetermined duration from the vibration of the second band 104b. The processor 128, at a step 328, actuates the vibrator 122 of the second band 104b at a third tacton if the second band 104b detects the presence of the first band 104 within the second predetermined distance after elapse of the predetermined duration from the actuation of the second band 104b at the second tacton. Otherwise, the method 300 moves to the step 302. Similar to the second band 104b, the first band 104a vibrates at the first tacton or the second tacton or the third tactor. In this manner, the sensory system 100 facilitates detection of various types of users in the vicinity of a user at a worksite. For example, the sensory system 100 can help busy, frazzled, distracted, or plain regular forklift drivers at a warehouse or a worksite, whose sight lines are impaired because of the fork and/or the load as the forklift drivers can feel pedestrian presence because of his/her band’s vibrations. In the same way, it will help pedestrian to detect when a forklift is approaching.

In another scenario, the sensory system 100 can help people walking into cranes’ work areas. Heavy loads, or load containing pieces that can fall, put pedestrian at risk, while they approach to the crane. Using the bands 104 of the sensory system 100, pedestrians can feel they are walking into a dangerous zone, due to the vibration in their bands 104 that communicates with the crane’s driver band 104.

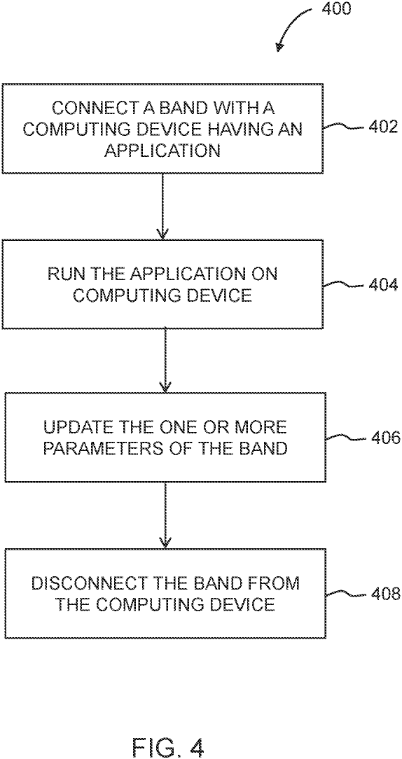

Referring to FIG. 4, a method 400 for configuring various parameters of each band 104 is shown. The method 400 includes a step 402, at which a supervisor connects the band 104 with a computing device, for example, a desktop computer, a laptop or a mobile phone, having an application that facilitates the configuration of various parameters of the band 104. The application enables a communication of the band 104 with the central station and enables updating the data associated with the band 104 in the controller 126 and the central station 200. In an embodiment, the band 104 is connected with the computing device via a USB cable. Alternatively, the band 104 and the computing device may be connected wirelessly, for example, via a Bluetooth connection. In an embodiment, the supervisor enters a security code in the band 104 and/or the computer via the application to enable the application to access the memory 130 of the controller 126 of the band 104.

Thereafter, the method 400 moves to a step 404, at which the application is run on the computing device. As the application is run on the computing device, the application recognizes the band 104 connected with computing device. In an embodiment, the supervisor enters a security code via the band 104 and/or the computer via the application to enable the application to access the data stored inside the controller 128 of the band 104. In embodiment, the application enables the supervisor to see the identification code, the alias or the name of the user associated with the band, the category of the band, the first predefined distance, the second predefined distance, and time for pausing or muting the band 104 between two vibration pulses. Further, at a step 406 of the method 400, the supervisor updates or changes the identification code, the alias or the name of the user associated with the band, the category of the band, the first predefined distance, the second predefined distance, and time for pausing or muting the band between two vibration pulses of the connected band via the application. Accordingly, the application saves the updated data associated with the parameters at the central station 200 and the band 104. Thereafter, at a step 408 of the method 400, the supervisor disconnects the band 104 from the computing device. In this manner, various parameters of the band 104 are configured.

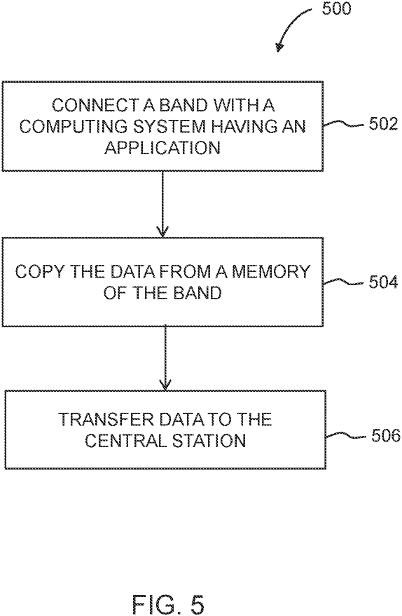

Referring to FIG. 5, a method 500 for transferring data stored inside each band 104 to the central station 200 is described. The processor 128 of the band is adapted store data related to interaction of the band 104 with other bands 104 present at the worksite. For example, the processor 128 is adapted to store the location of the band 104 when the associated vibrator 122 is actuated. The processor 128 stores the type of tacton associated with vibration for each interaction. The processor 128 also stores a date and a time of the data associated with each interaction. Also, the processor 128 stores the identification codes and the category of the bands 104 associated with each interaction.

The method 500 includes a step 502, at which the band 104 is connected with a computing system, for example, a desktop computer, a laptop computer, a mobile phone, etc., having an app that facilitates transfer of data, wirelessly or not upon user preference, from the band 104 to the central station 200. To facilitate the connection of the band 104 with the computing system, the computing system broadcast signals and the computing system is connected with the band 104 upon receipt of a code from the band 104. Thereafter, the method 500 moves to a step 504, at which the application copies the data stored inside the memory 130 of the band 104. Subsequently, the application, at a step 506 of the method 500, transfers the data to the central station 200 and associates the data with the identification code of the band 104. The information or the data stored for each band 104 can accessed for analysis purpose at the central station 200.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A sensory system, comprising:
a first band adapted to be worn by a first user; and
a second band adapted to communicate with the first band and worn by a second user, wherein each of the first band and the second band is associated with a category, the second band includes
a transceiver to facilitate a communication of the second band with the first band,
a sensor to determine a distance between the first band and the second band,
at least one vibrator to facilitate the vibration of the second band, and
a controller in communication with the transceiver, the at least one vibrator, and the sensor, and is configured to actuate the vibrator in response to
the category of the first band and the category of the second band, and
the determined distance of the second band from the first band.

2. The sensory system of claim 1, wherein the category includes a first category and a second category, and each of the first band and the second band is associated with one of the first category or the second category.

3. The sensory system of claim 2, wherein the first category indicates a first user category and the second category indicates a second user category.

4. The sensory system of claim 2, wherein the controller actuates the vibrator when at least one of the first band or the second band is associated with the first category.

5. The sensory system of claim 4, wherein the controller actuates the vibrator at a first tacton when one the first band and the second band is associated with the first category and other of the first band and the second band is associated with the second category and the determined distance is less than a first predefined distance.

6. The sensory system of claim 5, wherein the controller actuates the vibrator at a third tacton if the first band and the second band are present within the first predefined distance after an elapse of a predetermined time from an actuation of the vibrator.

7. The sensory system of claim 4, wherein the controller actuates the vibrator at a second tacton when each of the first band and the second band is associated with the first category and the determined distance is less than a second predefined distance.

8. The sensory system of claim 7, wherein the controller actuates the vibrator at a third tacton if the first band and the second band are present within the second predefined distance after an elapse of a predetermined time from an actuation of the vibrator.

9. A band adapted to be worn by a user, the band comprising:
a transceiver to facilitate a communication of the band with another band;
a sensor to determine a distance of the band from the another band;
at least one vibrator adapted to vibrate; and
a controller in communication with the transceiver, the vibrator, and the sensor, and is configured to actuate the vibrator in response to
a category of the band and a category of the another band, and
the determined distance of the band from the another band.

10. The band of claim 9, wherein the category includes a first category and a second category, and the band is associated with one of the first category or the second category.

11. The band of claim 10, wherein the controller is adapted to actuate the vibrator at a first tacton when the category of the band is different from the category of the another band and the determined distance is less than a first predefined distance.

12. The band of claim 11, wherein the controller is adapted to actuate the vibrator at a third tacton when the band is present within the first predefined distance of the another band after an elapse of a predetermined time from an actuation of the vibrator.

13. The band of claim 10, wherein the controller is adapted to actuate the vibrator at a second tacton in response to
the determined distance being less than a second predefined distance, and
the category of the band being identical to the category of the another band and the category of the first band being the first category.

14. The band of claim 13, wherein the controller is adapted to actuate the vibrator at a third tacton when the band is present within the second predefined distance of the another band after an elapse of a predetermined time from an actuation of the vibrator.

15. A method for detecting a presence of users in a zone, the method comprising:
providing a first band worn by a first user and a second band worn by a second user, wherein each of the first band and the second band is associated with a category;
determining a distance between the first band and the second band; and
vibrating at least one of the first band or the second band in response to
the categories of both the first band and the second band, and
the determined distance between the first band and the second band.

16. The method of claim 15, wherein the category includes a first category and a second category, and each of the first band and the second band is associated with one of the first category or the second category, wherein the first category indicates a first user category and the second category indicates a second user category.

17. The method of claim 16, wherein at least one of the first band or the second band vibrates at a first tacton when one of the first band and the second band is associated with the first category and other of the first band and the second band is associated with the second category and the determined distance is less than a first predefined distance.

18. The method of claim 17, wherein at least one of first band or the second band vibrates at the third tacton when the first band and the second band are within the first predefined distance after an elapse of a predetermined time from an actuation of at least one of first band or the second band.

19. The method of claim 16, wherein at least one of the first band or the second band vibrates at a second tacton when each of the first band and the second band is associated with the first category and the determined distance is less than a second predefined distance.

20. The method of claim 19, wherein at least one of first band or the second band vibrates at the third tacton when the first band and the second band are within the second predefined distance after an elapse of a predetermined time from an actuation of at least one of first band or the second band.

21. The band of claim 9, wherein vibrates at a fourth tacton when the battery has reach certain level of charge.

22. The band of claim 9, wherein possess a visual indicator to signal its state as on, low battery or off.

23. The band of claim 9, wherein it can be made of a stretchable material such as medical grade silicone, other similar or a combination of materials, and fitted around a user’s wrist, or adhere to a machinery, by a strap or a similar system.

24. The band of claim 9, wherein it is fed by a battery that can be rechargeable, such as a lithium-ion battery.
